(19) United States
(12) Patent Application Publication
(10) Pub. No.: US 2018/0248349 A1
(43) Pub. Date: Aug. 30, 2018

(54) GARAGE DOOR DE-ICER SYSTEM AND METHOD

(71) Applicants: Valerie Reed, Bessemer, MN (US); Brandi Rose Reed, Bessemer, MN (US); Cody Alan Reed, Bessemer, MN (US)

(72) Inventors: Valerie Reed, Bessemer, MN (US); Brandi Rose Reed, Bessemer, MN (US); Cody Alan Reed, Bessemer, MN (US)

(21) Appl. No.: 15/899,632

(22) Filed: Feb. 20, 2018

Related U.S. Application Data
(60) Provisional application No. 62/465,142, filed on Feb. 28, 2017.

(51) Int. Cl. H02G 7/16; E05F 15/44; G08C 17/02

(52) U.S. Cl. CPC H02G 7/16; G08C 17/02; E05F 15/44

(57) ABSTRACT

An overhead garage door seal may freeze to the floor/garage pad during winter months. A heating wire is placed inside the seal of the bottom of the garage door with a sensor on the outside. A timer can be used to activate the heating wire along with plugging it in to activate the heating wire. This prevents damage to the seal when ice forms because the ice is melted before opening the overhead garage door occurs.

### CROSS-REFERENCE TO RELATED APPLICATION(S)

The present application is related to and claims priority to U.S. Provisional Patent Application No. 62/465,142 filed Feb. 28, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of de-icers of existing art and more specifically relates to garage door de-icers.

### RELATED ART

During colder months of the year, people with overhead garage doors must be mindful of icy conditions. The bottom seal on a garage door may freeze to the ground, causing extensive damages to the door. If an individual tries to activate the door system, the seal may ‘stick’ to the ground destroying the seal, and expensive repairs are then required. Damage to the internal railing could also occur, incurring even more repair and maintenance costs. An effective alternative is needed.

U.S. Pat. No. 3,462,885 to Chester W. Ellingson Jr. relates to a door bottom weather sealing structure. The described door bottom weather sealing structure includes an automatic door bottom weather sealing structure disposed in a channel formed in the bottom of a door comprising a pair of interfitting channel members being transversely extensible and retractable in which the improvement consists of a flexible accordion gasket forming an air pocket with the bottom of the lower of said channel members to provide a flexible bottom sealing member and the side walls of said gasket member overlying the side walls of said channel members forming a sealed extensible enclosure for the moving parts of said door bottom sealing structure.

### SUMMARY OF THE INVENTION

In view of the foregoing disadvantages inherent in the known garage door de-icers art, the present disclosure provides a novel garage door de-icer system. The general purpose of the present disclosure, which will be described subsequently in greater detail, is to provide a garage door de-icer system for use in inclement weather.

A de-icer means for use with a garage (or other) door is disclosed herein. The de-icer includes a sensor, a heating filament, a wire harness, and a power supply. The garage door deicer system may comprise: a sensor which may include a flat front side, a flat rear side opposite the flat front side, and a thickness therebetween; the thickness may be sufficient to support the inner electronics of the sensor mountable to a planar surface of an outside-wall of a garage. The sensor may be a temperature sensor and may be wirelessly connectable to a heating filament. The temperature sensor may be weather resistant, and include a processor, a transceiver, and a memory module useful for controlling function(s). The temperature sensor may include a temperature regulator useful for preventing overheating of the heating filament. The temperature sensor may include a timer useful for timed activation of the de-icer.

A heating filament may include a first-end-a, a length-a and a second-end-a, the first-end-a of the heating filament, the length-a of the heating filament, and the second-end-a of the heating filament are coupled to a bottom edge of a garage-door, wherein the second-end-a terminates at an end of the garage-door. The heating filament may be replaceable and of sufficient thickness to carry power sufficient to thaw ice via produced heat being radiated.

A wire harness may include, a first-end-b, a length-b, and a second-end-b. The first-end-b may be communicatively coupled to (the thickness of) the sensor; wherein the length-b of the wire harness passes through a garage wall and the second-end-b of the wire harness is coupled to the first-end-a of the heating filament.

A power supply, may provide power to the sensor, heating filament, and wire harness. The power supply may be powered by a battery which may be rechargeable or be in electrical communication with an available AC powering source. The de-icer may further include an on/off switch may be useful for deactivation during warmer seasons and activation during frigid temperature seasons. The de-icer may even further include a remote control useful for activating the de-icer remotely. A mounting bracket may be included for mounting to the outside-wall of the garage. The de-icer may provide heat to de-ice a garage-door, with the sensor which may be able to detect frigid weather temperature and may activate the heating filament by sending a signal through the wire harness, which heats the heating filament and melts any surrounding ice to free the garage-door for use.

According to another embodiment, a method of using a de-icer is also disclosed herein. The method of installing/using a de-icer includes installing the de-icer to a garage door, programming functions of the de-icer, opening the garage door of a garage, controlling the de-icer with a remote-control and replacing a heating filament of the de-icer attached to a garage door (as needed).

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a garage door de-icer system, constructed and operative according to the teachings of the present disclosure.

FIG. 1 is a perspective view of the de-icer during an ‘in-use’ condition, according to an embodiment of the disclosure.

FIG. 2 is a perspective view of the de-icer of FIG. 1, according to an embodiment of the present disclosure.

FIG. 3 is a perspective view of the de-icer of FIG. 1, according to an embodiment of the present disclosure.

FIG. 4 is a diagram view of the de-icer of FIG. 1, according to an embodiment of the present disclosure.

FIG. 5 is a flow diagram illustrating a method of installing/using the de-icer, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a de-icing means and more particularly to a garage door de-icer system as used to improve the de-icing of a garage door which has been sealed by ice during inclement weather.

Generally, an overhead garage door seal may freeze to the floor/garage pad during winter months. A heating wire is placed inside the seal of the bottom of the garage door with a sensor on the outside. A timer can be used to activate the heating wire along with plugging it in to activate the heating wire. This prevents damage to the seal when ice forms because the ice is melted before opening the overhead garage door occurs.

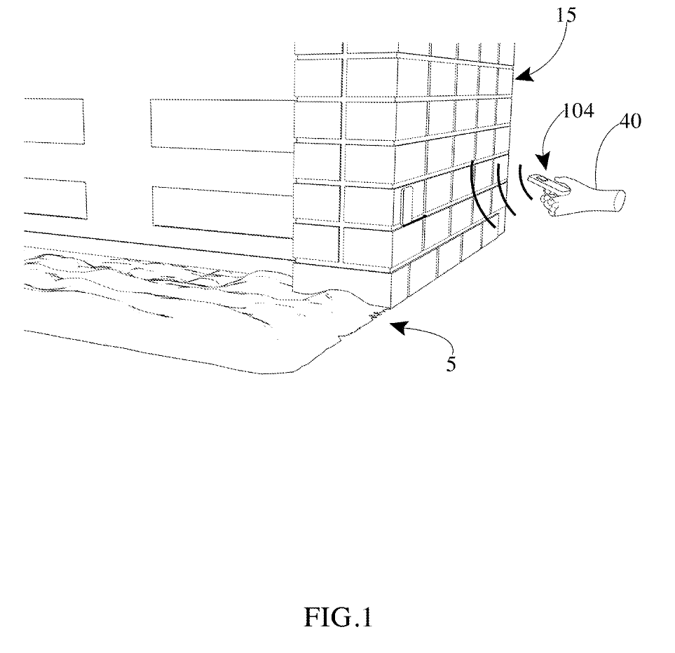

Referring now more specifically to the drawings by numerals of reference, there is shown in FIGS. 1-4, various views of a de-icer 100.

FIG. 1 shows a de-icer 100 during an ‘in-use’ condition 50, according to an embodiment of the present disclosure. Here, the de-icer 100 may be beneficial for use by a user 40 to provide heat to de-ice a garage-door (or other door), by using a sensor 110 which may be able to detect frigid weather and may activate a heating filament 120 by sending a signal through a wire harness 130, which heats the heating filament 120 and melts any surrounding ice to free the garage-door for use. As illustrated, the de-icer 100 may include a sensor 110, a heating filament 120, a wire harness 130, and a power supply 140.

According to one embodiment, the de-icer 100 may be arranged as a kit 105. In particular, the de-icer 100 may further include a set of instructions 107. The instructions 107 may detail functional relationships in relation to the structure of the de-icer 100 such that the de-icer 100 can be used, maintained, or the like, in a preferred manner.

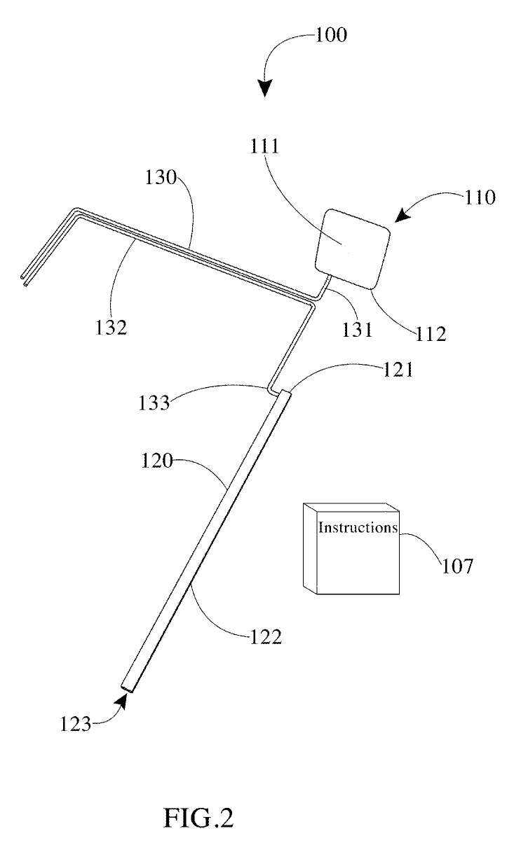

FIG. 2 shows the de-icer 100 of FIG. 1, according to an embodiment of the present disclosure. As above, the de-icer 100 may include a sensor 110 which may include a flat front side 111, a flat rear side 112 opposite the flat front side 111, and a thickness 113 therebetween; the thickness 113 may be sufficient to support the inner electronics of the sensor 110 mountable to a planar surface of an outside-wall of a garage 5.

A heating filament 120 may include a first-end-a 121, a length-a 122, and a second-end-a 123. The first-end-a 121 the length-a 122, and the second-end-a 123 of the heating filament 120 may be coupled to a bottom edge of a garage-door 10, wherein the second-end-a 123 terminates at an end of the garage-door 10. The heating filament 120 may be replaceable and of sufficient thickness to thaw ice. A wire harness 130 may include, a first-end-b 131, a length-b 132, and a second-end-b 133. The first-end-b 131 may be communicatively coupled to the thickness 113 of the sensor 110, wherein the length-b 132 of the wire harness 130 passes through a garage wall 15 and the second-end-b 130 of the wire harness 130 is coupled to the first-end-a 121 of the heating filament 120.

A power supply 140, may provide power to the sensor 110, heating filament 120, and wire harness 130. The de-icer 100 may further include an on/off switch 102 may be useful for deactivation during warmer seasons and activation during frigid temperature seasons. The de-icer 100 may even further include a remote control 104 useful for activating the de-icer 100 remotely. The de-icer 100 may provide heat via electrical power to de-ice a garage-door 10, with the sensor 110 which may be able to detect frigid weather and may activate the heating filament 120 by sending a signal through the wire harness 130, which heats the heating filament 120 and melts any surrounding ice to free the garage-door 10 for use.

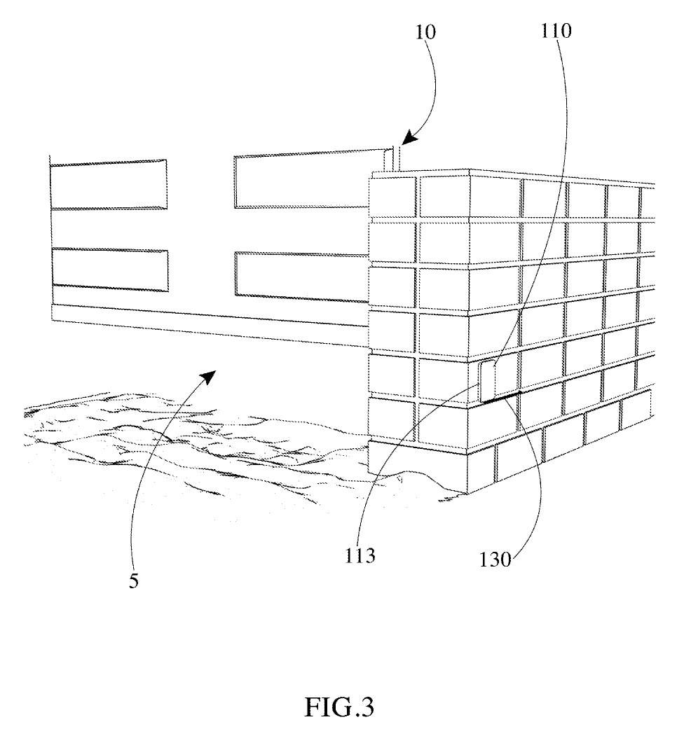

Referring now to FIG. 3, a perspective view of the de-icer 100 of FIG. 1, according to an embodiment of the present disclosure. A de-icer system 100 is installed on an outer-wall (or other suitable positioning) of a garage 5. The wire harness 120 is displayed entering to outer-wall of a garage 5 and the garage-door 10 is shown in an open position.

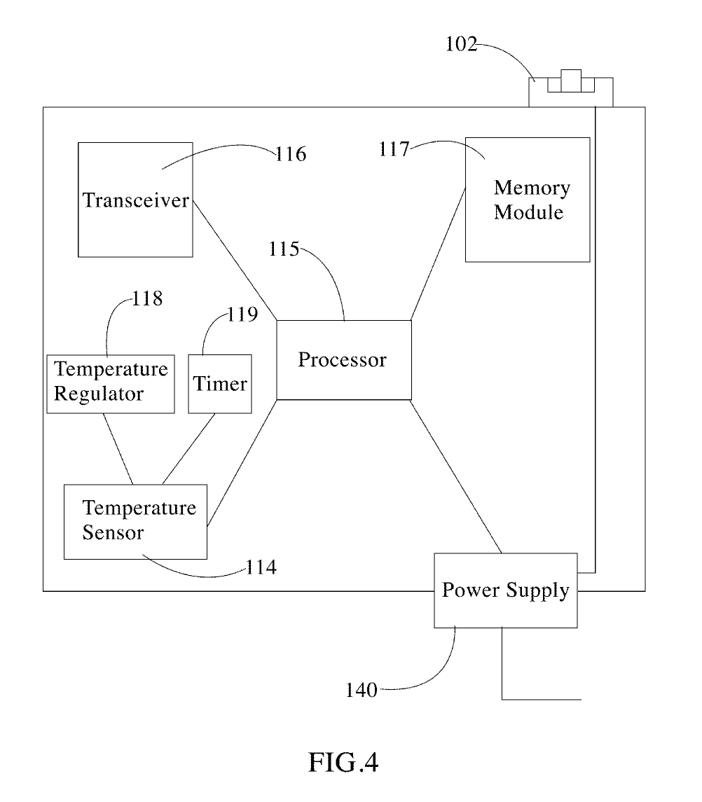

FIG. 4 is a schematic view of the de-icer 100 of FIG. 1, according to an embodiment of the present disclosure. The sensor 110 may include a temperature sensor 114 and may be wirelessly connectable to a heating filament 120. The sensor 110 may be weather resistant, and may also include a processor 115, a transceiver 116, and a memory module 117 useful for controlling function(s). The temperature sensor 114 may include a temperature regulator 118 useful for preventing overheating of the heating filament 120. The temperature sensor 114 may include a timer 119 useful for timed activation of the de-icer 100.

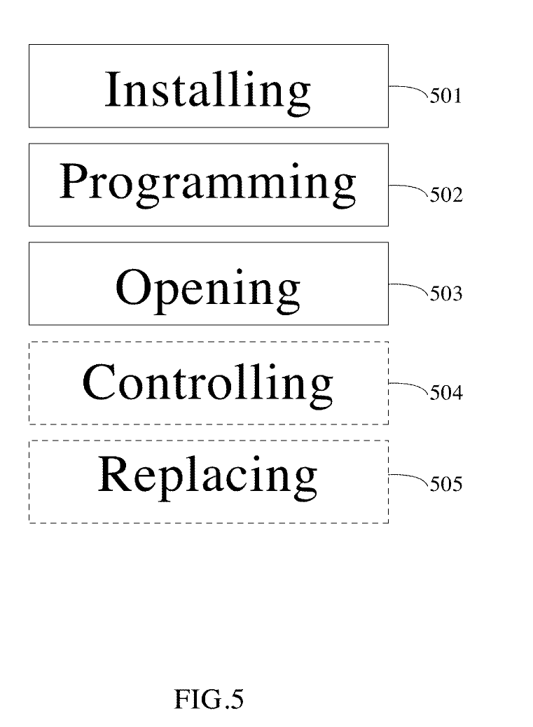

Referring now to FIG. 5 showing a flow diagram illustrating a method for using a de-icer 500, according to an embodiment of the present disclosure. In particular, the method for using a de-icer 500 may include one or more components or features of the de-icer 100 as described above. As illustrated, the method for using a de-icer 500 may include the steps of: step one 501, installing the de-icer to a garage door; step two 502, programming functions of the de-icer; step three 503, opening the garage door of a garage; step four 504, controlling the de-icer with a remote-control; and step five 505, replacing a heating filament of the de-icer attached to a garage door.

It should be noted that steps 504 and 505 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a de-icer 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A de-icer comprising:
a sensor including a flat front side, a flat rear side opposite the flat front side, and a thickness therebetween, the thickness being sufficient to support inner electronics of the sensor mountable to a planar surface of an outside-wall of a garage;
a heating filament including a first-end-a, a length-a and a second-end-a, the first-end-a of the heating filament, the length-a of the heating filament, and the second-end-a of the heating filament are coupled to a bottom edge of a garage-door; wherein the second-end-a terminates at an end of the garage-door;
a wire harness including, a first-end-b, a length-b, and a second-end-b, the first-end-b is communicatively coupled to the thickness of the sensor, the length-b of the wire harness passes through a garage wall and the second-end-b of the wire harness is coupled to the first-end-a of the heating filament, and
a power supply, the power supply provides power to the sensor, heating filament, and wire harness; and
wherein the de-icer provides heating means to de-ice said garage-door, the sensor able to detect frigid weather temperature and activates the heating filament by sending a signal through the wire harness, which heats the heating filament and melts any surrounding ice to free said garage-door for use.

2. The de-icer of claim 1, wherein the sensor is a temperature sensor.

3. The de-icer of claim 2, wherein the temperature sensor is wirelessly connectable to the heating filament.

4. The de-icer of claim 1, wherein the power supply is powered by a battery.

5. The de-icer of claim 4, wherein the battery of the power supply is rechargeable.

6. The de-icer of claim 2, wherein the temperature sensor includes a temperature regulator useful for preventing overheating of the heating filament.

7. The de-icer of claim 1, wherein the de-icer comprises a de-icer system including a remote control useful for activating the de-icer remotely.

8. The de-icer of claim 1, wherein the heating filament is replaceable.

9. The de-icer of claim 6, wherein the temperature sensor includes a timer useful for timed activation of the de-icer.

10. The de-icer of claim 1, wherein the de-icer includes an on/off switch useful for deactivation during warmer seasons and activation during frigid temperature seasons.

11. The de-icer of claim 2, wherein the temperature sensor includes a processor useful for controlling function(s).

12. The de-icer of claim 11, wherein the temperature sensor includes a transceiver useful for receiving communications from the remote control and alternately wireless communications.

13. The de-icer of claim 11, wherein the temperature sensor includes a memory module useful for storing programmed commands.

14. The de-icer of claim 1, wherein the heating filament is of sufficient thickness to thaw ice.

15. The de-icer of claim 1, wherein the de-icer includes a mounting bracket useful for mounting to the outside-wall of the garage.

16. The de-icer of claim 11, wherein the temperature sensor is weather resistant.

17. A de-icer comprising:
a sensor including a flat front side, a flat rear side opposite the flat front side, and a thickness therebetween, the thickness being sufficient to support inner electronics of the sensor mountable to a planar surface of an outside-wall of a garage, wherein the sensor is a temperature sensor and is wirelessly connectable to a heating filament, wherein the temperature sensor is weather resistant;
wherein the temperature sensor includes a processor useful for controlling function(s), a transceiver, and a memory module,
wherein the temperature sensor includes a temperature regulator useful for preventing overheating of the heating filament; and
wherein the temperature sensor includes a timer useful for timed activation of the de-icer;
a heating filament including a first-end-a, a length-a and a second-end-a, the first-end-a of the heating filament, the length-a of the heating filament, and the second-end-a of the heating filament are coupled to a bottom edge of a garage-door; wherein the second-end-a terminates at an end of the garage-door, and wherein the heating filament is replaceable;
wherein the heating filament is of sufficient thickness to thaw ice;
a wire harness including, a first-end-b, a length-b, and a second-end-b, the first-end-b is communicatively coupled to the thickness of the sensor, the length-b of the wire harness passes through a garage wall and the second-end-b of the wire harness is coupled to the first-end-a of the heating filament, and
a power supply, the power supply provides power to the sensor, heating filament, and wire harness, wherein the power supply is powered by a battery, wherein the battery is rechargeable, and
wherein the de-icer includes an on/off switch useful for deactivation during warmer seasons and activation during frigid temperature seasons;
wherein the de-icer comprises a de-icer system including a remote control useful for activating the de-icer remotely;
wherein the de-icer includes a mounting bracket useful for mounting to the outside-wall of the garage; and
wherein the de-icer provides heat to de-ice said garage-door, the sensor able to detect frigid weather and activates the heating filament by sending a signal through the wire harness, which heats the heating filament and melts any surrounding ice to free said garage-door for use.

18. The de-icer of claim 17, further comprising a set of instructions; and
wherein the de-icer is arranged as a kit.

19. A method of using a de-icer, the method comprising the steps of:
installing the de-icer to a garage door;
programming functions of the de-icer; and
opening the garage door of a garage.

20. The method of claim 19, further comprising the steps of:
controlling the de-icer with a remote-control; and
replacing a heating filament of the de-icer attached to the garage door.
